(19) United States
(12) Patent Application Publication
(10) Pub. No.: US 2005/0086831 A1
(43) Pub. Date: Apr. 28, 2005

(54) Rear cover assembly for washing machine and dryer and washing system using the same

(76) Inventor: Chang Won Ryu, Kyongsangnam-do (KR)

Correspondence Address: MCKENNA LONG & ALDRIDGE LLP, 1900 K STREET, NW, WASHINGTON, DC, 20006, US

(21) Appl. No.: 10/468,778

(22) PCT Filed: Dec. 27, 2002
(86) PCT No.: PCT/KR02/02459

(30) Foreign Application Priority Data
Dec. 28, 2001 (KR) 1020010087347

(51) Int. Cl. D06F 37/00; F26B 11/02

(52) U.S. Cl. 34/603; 68/3 R; 68/142

(57) ABSTRACT

Rear cover assemblies (100, 200) for washing machines and dryers including front panels(110, 210) each mounted on rear of a top cover fitted to an upper part of each of the washing machines (1) and the dryers (2), the front panels each having a seat (111, 211) of identical shape, and back panels (120, 210) each being formed to be fitted to the seat (111, 211) of the front panel (110, 210), the back panel being configured to allow accessories required for each of the washing machines (1) or each of the dryers (2) to be fitted thereto. These rear cover assemblies form a unified particular outer appearance in one set consisting of any selected two of the washing machines (1) and the dryers (2), and they are exchangeable such that the particular outer appearance can be maintained even if relative positions of the washing machines and the dryers within the one set are changed.

### TECHNICAL FIELD

The present invention relates to a washing system for washing and drying laundry, and more particularly, to a rear cover assembly for a washing machine or a dryer in the washing system.

### BACKGROUND ART

As known, since the washing machine and the dryer provide function supplementary to each other, the washing machine and the dryer are installed even in parallel when required. According to this, a washing system having independent washing machine and dryer combined as one set therein is put into practical use, recently. The washing system has the washing machine and the dryer coupled in view of functions, though independent from each other in view of structure. Moreover, for giving a sense of one system to a user, the washing system has a unified design on the whole. Depending on specification, the washing system may be provided with a control panel, and a rear cover assembly projected from rear of the washing system. Accordingly, in the washing system, particularly, the rear cover assemblies on the washing machine and dryer respectively are designed to have one specific appearance.

In the meantime, an air discharge structure for the dryer, and water supply/drain structures for the washing machine may vary with a structure of a house. Therefore, it is required that the washing machine and the dryer in the washing system are installed in the vicinity of the water supply/drain structures and the air discharge structure. However, even if the washing system is installed suitable to the house structure, the washing system may not be harmonious in view of the outer appearance. For an example, in the washing system, the dryer may be disposed on a right side of the washing machine, and under this arrangement, the washing system may be designed to have a particular outer appearance on the whole. However, if it is required that the dryer is disposed on a left side of the washing machine suitable to a structure of a house, arrangement of the washing machine and the dryer may not be harmonious.

### DISCLOSURE OF INVENTION

An object of the present invention for solving the foregoing problem is to provide a washing system which can maintain an initial outer appearance even if an arrangement of independent appliances in the washing system is changed.

The object of the present invention can be achieved by providing rear- cover assemblies for washing machines and dryers including front panels each mounted on rear of a top cover fitted to an upper part of each of the washing machines and the dryers, the front panel having a seat, and back panels each fitted to the seat of the front panel, the back panel having a system to fit accessories required for each of the washing machines or each of the dryers thereto, wherein a unified particular outer appearance is formed for one set consisting of any selected two of the washing machines and the dryers, such that the particular outer appearance can be maintained for the one set even if relative positions of the washing machines and the dryers within the one set are changed.

The particular outer appearance is formed by the front panels, and more precisely formed by upper part outlines of the front panels. For forming the particular outer appearance, it is preferable that the front panels are symmetric within the one set.

The front panel includes a control panel having a system enabling a user to operate the washing machine or the dryer, and the control panel includes various buttons for giving operational orders and a display window for displaying an operation state. The control panel is unified with the front panel, or detachable from the front panel, and the windows and buttons have identical positions in the different control panels in the one set. The seat is formed by cutting off a rear surface of the front panel.

In the back panel, the accessories for the washing machine include a water supply tube and wires, and the accessories for the dryer include wire. It is preferable that the back panel of the dryer is formed of a metal. More preferably, the back panel is formed unified with the top cover.

In another aspect of the present invention, there is provided a washing machine including a cabinet, a washing tub, or drum mounted in the cabinet rotatable by power means for washing laundry, a top cover for covering an upper part of the cabinet, and a rear cover having a front panel mounted in a rear part of the top cover having a form of seat and a back panel having a system for fitting various accessories thereto and a shape to be fitted to the seat in the front panel, wherein, when the washing machine is combined with another washing machine or a dryer having identical rear cover, the rear covers form a unified particular outer appearance such that the particular outer appearance is maintained even if positions of the washing machine and the another washing machine or the dryer are interchanged.

In further aspect of the present invention, there is provided a dryer including a cabinet, a drum mounted in the cabinet rotatable by power means for drying laundry, a top cover for covering an upper part of the cabinet, and a rear cover having a front panel mounted in a rear part of the top cover having a form of seat and a back panel having a system for fitting various accessories thereto and a shape to be fitted to the seat in the front panel, wherein, when the dryer is combined with another dryer or a washing having identical rear cover, the rear covers form a unified particular outer appearance such that the particular outer appearance is maintained even if positions of the dryer and the another dryer or the washing machine are interchanged.

In still further aspect of the present invention, there is provided a washing system including a washing machine having a cabinet, a washing tub, or drum mounted in the cabinet rotatable by power means for washing laundry, a top cover for covering an upper part of the cabinet, and a rear cover having a front panel mounted in a rear part of the top cover having a form of seat and a back panel having a system for fitting various accessories thereto and a shape to be fitted to the seat in the front panel, and a dryer having a cabinet, a drum mounted in the cabinet rotatable by power means for drying laundry, a top cover for covering an upper part of the cabinet, and a rear cover having a front panel mounted in a rear part of the top cover having a form of seat and a back panel having a system for fitting various accessories thereto and a shape to be fitted to the seat in the front panel, wherein the rear covers of the washing machine and dryer form a unified particular outer appearance on the whole, and are interchangeable to maintain the outer appearance.

### BRIEF DESCRIPTION OF DRAWINGS

The accompanying drawings, which are included to provide a further understanding of the invention, illustrate embodiments of the invention and together with the description serve to explain the principles of the invention:

In the drawings:

FIG. 1 illustrates a perspective view of a washing system in accordance with a preferred embodiment of the present invention;

FIG. 2 illustrates a back side perspective view of a washing system of the present invention showing a rear cover assembly in detail; and

FIGS. 3A˜3D illustrate back side perspective views each showing the steps of a process for interchanging the rear cover assemblies in the washing system of the present invention.

### BEST MODE FOR CARRYING OUT THE INVENTION

Reference will now be made in detail to the preferred embodiments of the present invention, examples of which are illustrated in the accompanying drawings. In description of the embodiments, the same parts will be given the same names and reference numerals, and iterative description of which will be omitted.

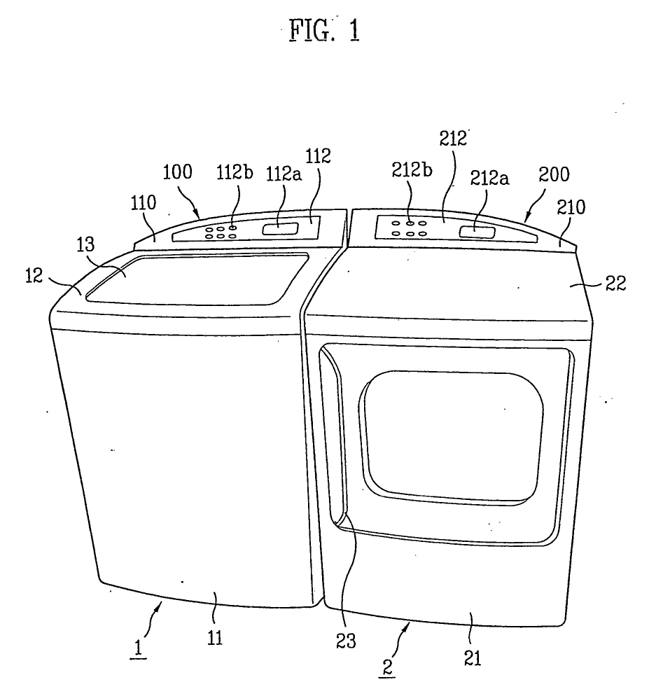

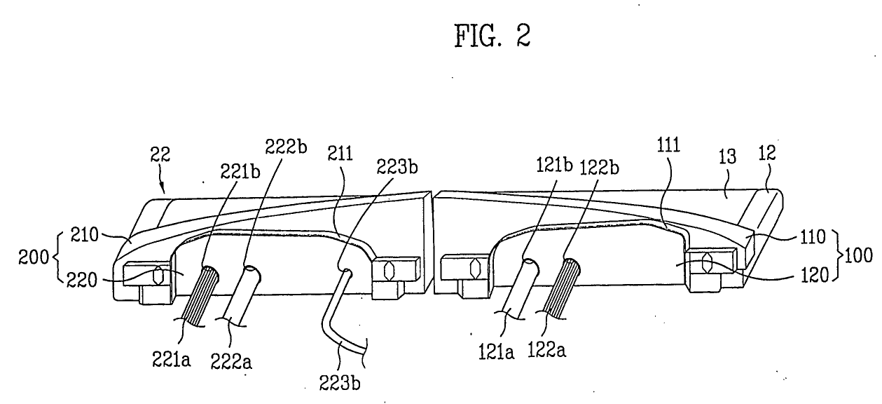

FIG. 1 illustrates a perspective view of a washing system in accordance with a preferred embodiment of the present invention, and FIG. 2 illustrates a back side perspective view of a washing system of the present invention showing a rear cover assembly in detail, referring to which the washing system of the present invention will be described.

The washing system of the present invention includes one set having a washing machine 1 and a dryer 2 combined therein. As shown, the washing machine 1 and the dryer 2 have independent and separated structures, but are combined to form the washing system. The washing machine 1 includes a housing and various components fitted in the housing for washing, and the dray 2 also has a similar structure. Each of the housings includes a cabinet 11 or 21 in a lower part, a top cover 12 or 22 on the cabinet 11 or 21, and a rear cover 100 or 200 in rear of the top cover 12 or 22. The lower cabinet 11 or 21 holds and mounts key components of the washing machine 1 or the dryer 2 therein. The top cover 12 or 22 covers an upper part of the cabinet 11 or 21, for protection of the components. The rear cover 100 or 200 includes a control panel 112 or 212 for operation of the washing machine 1 or the dryer 2, and covers a controller operably connected to the panel 113 or 212. Meanwhile, the door 13 or 23 may be fitted to the top cover 12 or the cabinet 21 depending on an arrangement of the components.

In the case of the washing machine 1, there are a washing tub and- driving means for driving the washing tub inside of the housing. Laundry is introduced into the washing tub through the door 13, and washed and extracted of water as the washing tub rotated. Moreover, in the case of the dryer 2, there are a drying drum, driving means for rotating the drying drum, and devices for heating air inside of the housing. Laundry washed in the washing machine is introduced into the drying drum through the door 23, and dried by using the heating devices. For better drying of the laundry, the drying drum is rotated by the driving means. Therefore, a general washing process started from the washing machine 1 is finished at the dryer 1.

In the washing system of the present invention, the washing machine 1 and the dryer 2 are arranged in parallel such that functions of the washing machine 1 and the dryer 2 are connected, closely. According to this, the user can process an entire washing process in a lot, more conveniently. That is, after washing the laundry at the washing machine 1, the user takes out the laundry from the washing machine and dries the laundry at an adjacent dryer 2 at once. Moreover, as shown, not only the functions, but also the designs are preferably harmonized, the washing machine 1 and the dryer 2 in the washing system are designed to have the same heights and widths. In the meantime, in general the rear covers 100 and 200 are projected from the top covers 12 and 22 for easy handling by the user. In view of overall design of the washing system, it is important to unify the designs of the rear covers 100 and 200 into one. Furthermore, it is preferable that a combination of rear covers 100 and 200 has a particular outer appearance. For an example, FIG. 1 illustrates the rear covers 100 and 200 which form a smooth semi-elliptic form. Such rear covers 100 and 200 of the present invention will be explained in more detail.

Referring to FIG. 2, the rear cover 100 or 200 includes the front panel 110 or 210 on the top cover 12 or 22 and a back panel 120 or 220 in rear of the front panel 110 or 210.

The front panel 110 or 210 is detachably fitted to rear of the top cover 12 or 22. As described before, the front panel 110 or 210 is projected from the top cover 12 or 22 to a height so that the user can handle the control panel 112 or 212 in the front panel 110 or 210 with easy. Meanwhile, referring to FIGS. 1 and 2, since the front panels 110 and 210 are exposed to a front face of the washing system, and represents a whole shape of the rear covers 100 and 200, it can be actually known that the front panels 110 and 210 form a unified outer appearance, i.e., a smooth semi-elliptic form, at the time the rear covers 100 and 200 are combined. Particularly, since the projected front panels 110 and 210 form a top part outline of entire washing system, the top part outline of the front panels 110 and 210 form the semi-elliptic form, more significantly. Moreover, for forming a particular outer appearance, the front panels 110 and 210 may be asymmetrical. However, for easy design and fabrication, it is preferable that the front panels 110 and 210 are symmetrical.

Referring to FIG. 2, in the rear part of the front panel 110 or 210, a seat 111 or 211 for a back cover 120 is provided. The seat 111 or 211 is formed by cutting a part of the rear surface of the panel 110 or 210 away so that the cut away part can receive the back cover 120, actually. In more detail, the seat 111 or 211 has a form in the front panel 110 or 210. That is, the seat 111 of the washing machine and the seat 211 of the dryer have identical sizes and forms.

The control panel 112 or 212 is fitted to a front part of the front panel 110 or 210. The control panel 112 or 212 includes a display window 112a or 212a for displaying an operation state and a plurality of buttons 112b and 212b for giving operational orders. The user presses the buttons 112b or 212b for generating an electrical signal to control operation, in response to which signal the controller makes the washing machine or the dryer to carry out a particular function. Information on the operation is provided to the user through the window 112a or 212a. In more detail, the control panel 112 or 212 may be unified with, or detachably fitted to the front panel 110 or 210. As shown in FIG. 1, in the case of the unified control panels 112 and 212, the windows 112a and 212a are formed at identical positions in different control panels 112 and 212, and the buttons 112b and 212b are also formed in the same styles. That is, as shown, the window 112a of the washing machine and the window 212a of the dryer are positioned in right parts of the control panels 112 and 212 in the drawing, and buttons 112b of the washing machine and buttons 212b of the dryer are positioned left parts of the control panels 112 and 212. Therefore, even if the control panel 112 of the washing machine is fitted in place of the control panel 212 of the dryer, the control panel 112 can carry out the same functions for the dryer described before. Moreover, under the same reason, it is preferable that other characteristics except the positions, i.e., shapes colors of the windows and buttons are formed identical to each other. On the other hand, in the case of the detachable control panel 112 or 212, the detachable control panel 112 or 212 may be detached from a prior panel, and attached to a new panel again, when the front panel 110 or 210 is interchanged with the new panel. Therefore, since the detachable control panels 112 and 212 can be remained at original positions, windows and buttons thereof may be identical or have different positions and forms, selectively.

The back panel 120 or 220 is required to have accessories required for the washing machine 1 or the dryer 2 fitted thereto. As known, at least the washing machine 1 and the dryer require the drain structure and the air discharge structure positioned at outsides thereof. The accessories not only connect the drain and the air discharge structure and the washing machine 1 and the dryer 2 for making normal operation, but also have various supplementary functions. As shown in FIG. 2, in a case of the washing machine 1, the accessories include a water supply tube 121a and various wires 122a. The water supply tube 121a connects an external water supply source (city water tap) and a washing tub inside of the washing machine, for supplying washing water from the water supply source to an inside of the washing machine. The wires 122a electrically connect an external power source to inside devices. Therefore, for extending the wires 122a and the water supply tube 121a, the back panel 120 actually has openings 121b and 122b suitable for the wires 122a and the water supply tube 121a. In the case of the dryer 2, the accessories may be various wires 221a, for connecting the dryer to the external power source. When,the dryer 2 has a burner, the dryer 2 is required to have an exhaust pipe 222a and a ground structure 223a. The exhaust pipe 222a is provided for discharging hot air which is produced by the burner and dries the laundry through an exhaust structure of the house. The ground structure 223a is provided for fire protection since the dryer 2 has a combustion device, such as the burner. When the dryer 2 uses a gas, a gas tube is provided additionally. Therefore, alike the back panel of the washing machine, the back panel 220 of the dryer has openings 221b, 222b, and 223b for the accessories. Owing to the hot air, the exhaust tube 222a is heated to a substantial temperature. Therefore, it is preferable that the back panel 220 of the dryer is formed of a metal of good heat resistance. Opposite to this, the back panel 120 of the washing machine, which requires no heat resistance, may be formed of plastic.

The back panel 120 or 220 is formed to fit to the seat 111 or 211 of the front panel. That is, a shape and a size of the back panel 120 or 220 is defined by the seat 111 or 211 for seating thereon. Therefore, as explained, since the seats 111 and 211 are identical, the back panels 120 and 220 are also identical in view of shapes and sizes. The back panel 126 or 220 is seated on the seat 111 or 211, to form a part of a rear surface of the front panel 110 or 210, in another words, to cover a part of rear surface. Since the back panel 120 or 220 has a system suitable to particular accessories, the back panel 120 or 220 may be unified with the top cover 12 or 22, unable to detach therefrom. Such unified back panel 120 or 220 is more favorable for stable support of the accessories, too.

As described, seats 111 and 112 of the washing machine and the dryer are formed identical to each other. Alikely, the back panels 120 and 220 have the same shapes, such that the back panels 120 and 220 can be seated on any of the seats 111 and 112. Eventually, the front panels 110 and 220 are interchangeable. Furthermore, even if an overall particular outer appearance of the washing system is not harmonious owing to a relative positional change of the washing machine 1 and the dryer 2, the front panels 110 and 210 may be interchanged for restoration of the particular outer appearance. That is, in overall, the interchange of the front panels 110 and 210 brings about a result in which the rear covers 100 and 120 are interchanged, entirely. A process for interchanging such rear covers will be described in detail with reference to related drawings.

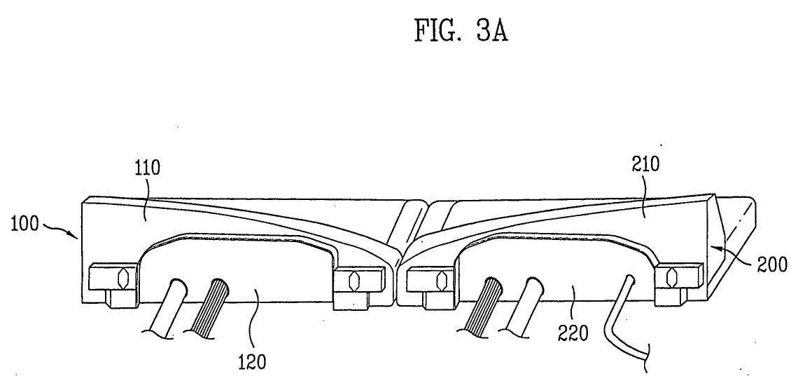

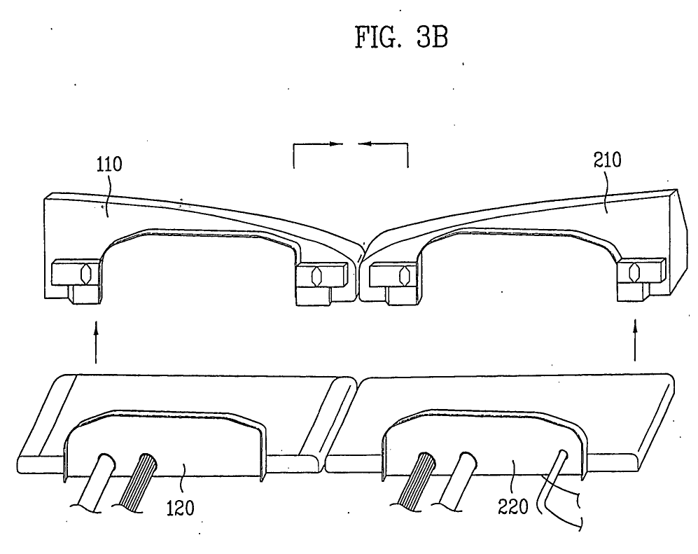

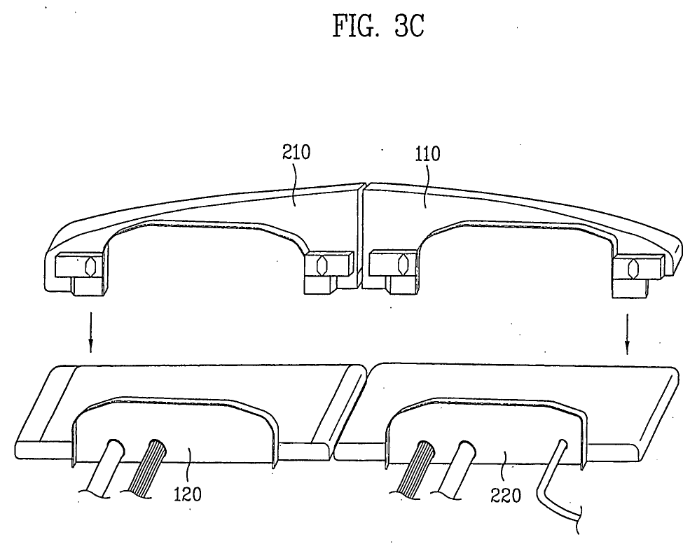

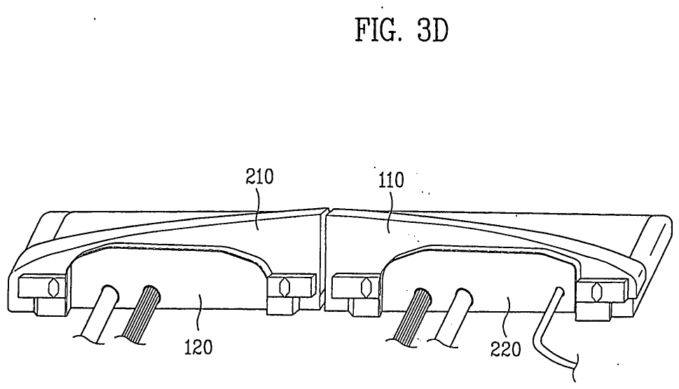

FIGS. 3A˜3D illustrate back side perspective views each showing the steps of a process for interchanging the rear cover assemblies in the washing system of the present invention. Alike FIG. 2, for clarity and simplicity of the drawings, only key parts of the entire washing system are shown.

FIG. 3A illustrates a washing system of which initial particular outer appearance is changed. In general, the washing system is designed such that one of arrangements of the washing machine 1 and the dryer 2 (for an example, the washing machine 1 is positioned on a left side of the dryer 2) exhibits a unified outer appearance. Therefore, it can be known that the outer appearance in FIG. 3A shows positions of the washing machine 1 and the dryer 2 are interchanged. On the other hand, as described, since widths and heights of the washing machine 1 and the dryer 2 in the unified washing system are identical basically, even if the positions are interchanged, the positional interchange gives no influence to an outer appearance unification of the entire washing system. However, since the rear covers 100 and 200 form a particular unified outer appearance in a state the rear covers 100 and 200 are projected, and combined to each other, when the positions of the washing machine I and the dryer 2 are interchanged, despite of the identical heights and widths, an overall outer appearance of the washing system is not harmonious. In FIG. 3A, though the washing machine 1 is positioned on a right side of the dryer 1 initially when seen from rear of the washing machine 1, the washing machine 1 is shifted to a left side of the dryer 2 due to various reasons, such as a structure of the house, and the like.

Referring to FIG. 3B, in a case like this, at first, the front panel 110 or 210 is detached from the top cover 12 or 22. When the control panel 112 or 212 is detachable from the front panel 110 or 210, only the front panel 110 or 210 is detached except the control panel 112 or 212. If the control panel 112 or 212 and the front panel 110 or 210 are unified, the control panel 112 or 212 is detached together with the front panel 110 or 210. As shown, since the back panels 120 and 220 have systems to receive accessories of the washing machine 1 and the dryer 2 respectively, the back panels 120 and 220 are not interchangeable.

Then, the front panels 110 and 210 are interchanged. As shown in FIG. 3C, according to this, the front panel 110 of the washing machine is moved from a left side to the right side on an upper side 6f the dryer 2, and the front panel 210 of the dryer is moved from a right side to a left side on an upper side of the washing machine.

Referring to FIG. 3D, finally, the interchanged front panels 110 and 220 are fastened to the washing machine and the dryer 2, respectively. That is, as shown, the front panel 110 of the washing machine is fitted to the top cover 22 of the dryer 2, and the front panel 210 of the dryer is fitted to the top cover 12 of the washing machine. At a same time, the back panel 120 of the washing machine is fitted to the seat 211 of the dryer, and the back panel 220 of the dryer is fitted to the seat 111 of the washing machine. As described before, this interchange of the front panels 110 and 210 is made possible by the identical seats 111 and 112 and the back covers 120 and 220. The control panels 112 and 212 detachable from the front panels are left at originally fitted washing machine 1 and the dryer 2, and fitted to the interchanged front panels. On the other hand, the unified control panels 112 and 212 are interchanged together with the front panels 110 and 210. However, the windows 112a and 212a and the buttons 112b and 212b are formed at the same positions, the windows 112a and 212a and the buttons 112b and 212b can carry out the same functions even after the front panels 110 and 210 are interchanged. Moreover, it is preferable that fitting structures for the front covers are formed identical on the top covers 12 and 22 for interchange of the front panels 110 and 210. For an example, the fitting structures are inclusive of the seats and fastening parts for the front panels 110 and 210. However, in the washing system, sizes of the washing machine 1 and the dryer 2 and sizes of the rear covers 100 and 200 dependent thereto are basically identical, the fitting structures are of course identical from the beginning. Even if there is a little difference of the fitting strictures, under the same reason, the front panels 110 and 210 can be made interchangeable by using adapters.

The interchange of the front panels 110 and 210 restores the unharmonious outer appearance of the rear covers 100 and 200 into the initial unified particular outer appearance again, which brings about a result in which the outer appearance of the washing system is harmonious, actually. Moreover, the back panels 120 and 220 also permit the washing machine 1 and the dryer 2 to have continuous rear surfaces together with the seats 111 and 211, which also permit an overall outer appearance of the washing system more harmonious. As a result, in the present invention, the interchange of the front panels 110 and 210 has an effect of an interchange of the rear covers 100 and 210 actually, and moreover makes the user unable to aware of a change of the outer appearance.

In the meantime, though the foregoing embodiment discloses a washing system including one washing machine and one dryer, the present invention is not limited to this. Rather, the washing system of the present invention may include two washing machines as one set, or two dryers as one set, as the case demands. As described before, in those embodiments too, the rear covers may have interchangeable system, to permit the washing system to maintain one unified particular outer appearance even if positions of the appliances in the washing system are changed. Thus, since those embodiments are identical to the embodiment described in detail actually, detailed description of those embodiments will be omitted.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

Industrial Applicability

In the washing system of the present invention, owing to seats of front panels formed identical to each other and the back panel fitted to the seats and also formed identical to each other, the front panels are made mountable to any of the washing machine and the dryer. Therefore, even if the washing system becomes to have an unharmonious outer appearance due to change of positions of the washing machine and the dryer, the front panels may be interchanged so that a particular outer appearance of the washing system is restored. As a result, the positions of the washing machine and the dryer in the washing system can be changed as desired without change of the outer appearance, thereby permitting the user convenient.

1. Rear cover assemblies for washing machines and dryers comprising:
front panels each mounted on rear of a top cover fitted to an upper part of each of the washing machines and the dryers, the front panels each having a seat of identical shape; and
back panels each being formed to be fitted to the seat of the front panel, the back panels be configured to allow accessories required for each of the washing machines or each of the dryers to be fitted thereto,
wherein the rear cover assemblies form a unified particular outer appearance in one set consisting of any selected two of the washing machines and the dryers, and the rear cover assemblies are exchangeable in the one set such that the particular outer appearance can be maintained for the one set even if relative positions of the washing machines and the dryers within the one set are changed.

2. The rear cover assemblies as claimed in claim 1, wherein the particular outer appearance is formed by the front panels.

3. The rear cover assemblies as claimed in claim 2, wherein the particular outer appearance is formed by upper part outlines of the front panels.

4. The rear cover assemblies as claimed in claim 2, wherein the front panels are symmetric within the one set.

5. The rear cover assemblies as claimed in claim 1, wherein the front panel includes a control panel enabling a user to operate the washing machine or the dryer.

6. The rear cover assemblies as claimed in claim 5, wherein the control panel includes various buttons for giving operational orders and a display window for displaying an operation state.

7. The rear cover assemblies as claimed in claim 5, wherein the control panel is unified with the front panel, or detachable from the front panel.

8. The rear cover assemblies as claimed in claim 7, wherein the windows and buttons have identical positions in the different control panels in the one set.

9. The rear cover assemblies as claimed in claim 1, wherein the seat is formed by cutting off a rear surface of the front panel.

10. The rear cover assemblies as claimed in claim 1, wherein the accessories for the washing machine include a water supply tube and wires.

11. The rear cover assemblies as claimed in claim 1, wherein the accessories for the dryer include wire.

12. The rear cover assemblies as claimed in claim 1, wherein the back panel of the dryer is formed of a metal.

13. The rear cover assemblies as claimed in claim 1, wherein the back panel is formed unified with the top cover.

14. A washing machine comprising:
a cabinet;
a washing tub, or drum mounted in the cabinet rotatable by power means for washing laundry;
a top cover for covering an upper part of the cabinet; and
a rear cover including;
a front panel mounted in a rear part of the top cover and having a seat of a predetermined shape, and
a back panel configured to allow various accessories to be fitted thereto, the back panel being formed to be fitted to the seat in the front panel,
wherein, when the washing machine is combined with another washing machine or a dryer having identical rear cover, the rear covers form a unified particular outer appearance, and the rear covers are exchangeable such that the particular outer appearance is maintained even if positions of the washing machine and the another washing machine or the dryer are interchanged.

15. The washing machine as claimed in claim 14, wherein the particular outer appearance is formed by the front panels.

16. The washing machine as claimed in claim 15, wherein the particular outer appearance is formed by upper part outlines of the front panels.

17. The washing machine as claimed in claim 15, wherein the front panels are symmetric.

18. The washing machine as claimed in claim 14, wherein the front panel includes a control panel enabling a user to operate the washing machine.

19. The washing machine as claimed in claim 18, wherein the control panel includes various buttons for giving operational orders and a display window for displaying an operation state.

20. The washing machine as claimed in claim 18, wherein the control panel is unified with the front panel, or detachable from the front panel.

21. The washing machine as claimed in claim 20, wherein the windows and buttons have identical positions in the different control panels.

22. The washing machine as claimed in claim 14, wherein the seat is formed by cutting off a rear surface of the front panel.

23. The washing machine as claimed in claim 14, wherein the accessories include a water supply tube and wires.

24. The washing machine as claimed in claim 14, wherein the back panel is formed unified with the top cover.

25. A dryer comprising:
a cabinet;
a drum mounted in the cabinet rotatable by power means for drying laundry;
a top cover for covering an upper part of the cabinet; and
a rear cover including;
a front panel mounted in a rear part of the top cover and having a seat of a predetermined shape, and
a back panel be configured to allow various accessories to be fitted thereto, the back panel being formed to be fitted to the seat in the front panel,
wherein when the dryer is combined with another dryer or a washing having identical rear cover, the rear covers form a unified particular outer appearance, and the rear covers are exchangeable such that the particular outer appearance is maintained even if positions of the dryer and the another dryer or the washing machine are interchanged.

26. The dryer as claimed in claim 25, wherein the particular outer appearance is formed by the front panels.

27. The dryer as claimed in claim 26, wherein the particular outer appearance is formed by upper part outlines of the front panels.

28. The dryer as claimed in claim 26, wherein the front panels are symmetric.

29. The dryer as claimed in claim 25, wherein the front panel includes a control panel enabling a user to operate the dryer.

30. The dryer as claimed in claim 29, wherein the control panel includes various buttons for giving operational orders and a display window for displaying an operation state.

31. The dryer as claimed in claim 29, wherein the control panel is unified with the front panel, or detachable from the front panel.

32. The dryer as claimed in claim 31, wherein the windows and buttons have identical positions in the different control panels.

33. The dryer as claimed in claim 25, wherein the seat is formed by cutting off a rear surface of the front panel.

34. The dryer as claimed in claim 25, wherein the accessories include wires.

35. The dryer as claimed in claim 25, wherein the back panel is formed of a metal.

36. The dryer as claimed in claim 25, wherein the back panel is formed unified with the top cover.

37. A washing system comprising:
a washing machine including a cabinet, a washing tub or drum mounted in the cabinet rotatable by power means for washing laundry, a top cover for covering an upper part of the cabinet, and a rear cover having a front panel mounted in a rear part of the top cover and having a seat of a predetermined shape and a back panel configured to allow various accessories to fitted thereto and formed to be fitted to the seat in the front panel; and
a dryer including a cabinet, a drum mounted in the cabinet rotatable by power means for drying laundry, a top cover for covering an upper part of the cabinet, and a rear cover having a front panel mounted in a rear part of the top cover and having a seat identical with the seat of the washing machine and a back panel configured to allow fitting various accessories to be fitted thereto and formed to be fitted to the seat in the front panel,
wherein the rear covers of the washing machine and dryer form a unified particular outer appearance on the whole, and are exchangeable to maintain the outer appearance.

38. The washing system as claimed in claim 37, wherein the particular outer appearance is formed by the front panels of the washing machine and the dryer.

39. The washing system as claimed in claim 3S, wherein the particular outer appearance is formed by upper part outlines of the front panels of the washing machine and the dryer.

40. The washing system as claimed in claim 2, wherein the front panels of the washing machine and the dryer are symmetric.

41. The washing system as claimed in claim 37, wherein the front panels include control panels each enabling a user to operate the washing machine or the dryer.

42. The washing system as claimed in claim 41, wherein the control panel includes various buttons for giving operational orders and a display window for displaying an operation state.

43. The washing system as claimed in claim 41, wherein the control panel is unified with the front panel, or detachable from the front panel.

44. The washing system as claimed in claim 43, wherein the windows and buttons have identical positions in the control panels of the washing machine and the dryer.

45. The washing system as claimed in claim 37, wherein the seats are formed by cutting off rear surfaces of the front panels of the washing machine and the dryer.

46. The washing system as claimed in claim 37, wherein the accessories for the washing machine include a water supply tube and wires.

47. The washing system as claimed in claim 37, wherein the accessories for the dryer include wires.

48. The washing system as claimed in claim 37, wherein the back panel of the dryer is formed of a metal.

49. The washing system as claimed in claim 37, wherein the back panel is unified with the top cover.
